(19) United States
(12) Patent Application Publication
(10) Pub. No.: US 2024/0046189 A1
(43) Pub. Date: Feb. 8, 2024

(54) MACHINE LEARNING OPTIMIZATION OF EXPERT SYSTEMS

(71) Applicant: CoachEm Inc., Woodstock, CT (US)

(72) Inventors: Colum Lundt, Woodstock, CT (US); Matthew Zanni, Woodstock, CT (US); Owen Lawlor, Woodstock, CT (US)

(21) Appl. No.: 18/302,397

(22) Filed: Apr. 18, 2023

Related U.S. Application Data
(60) Provisional application No. 63/394,858, filed on Aug. 3, 2022.

(51) Int. Cl. G06Q 10/0639; G06N 5/046

(52) U.S. Cl. CPC G06Q 10/0639; G06N 5/046

(57) ABSTRACT

Methods, systems, and apparatus, including computer programs encoded on computer-storage media, for machine learning optimization of expert systems. Techniques described herein include systems and methods to train and use machine learning networks to supplement expert systems. In some cases, expert systems can be configured to perform one or more operations, such as providing corrections for employee performance. Machine learning networks can obtain output from expert systems and learn corrections for the expert systems based on the provided output.

### CROSS-REFERENCE TO RELATED APPLICATIONS

This application claims priority to U.S. Provisional Application No. 63/394,858, filed Aug. 3, 2022, the entirety of which is hereby incorporated by reference.

### FIELD

This specification generally relates to machine learning models, e.g., models used to optimize expert systems.

### BACKGROUND

Expert systems allow automatic actions to occur based on input data for a broad range of possible inputs. In traditional systems, domain experts will populate a database for an expert system. The expert system can use the data in the database to generate output corresponding to received input.

### SUMMARY

Techniques described herein include systems and methods to train and use machine learning networks to supplement expert systems. In some cases, expert systems can be configured to perform one or more operations, such as providing corrections for employee performance. Machine learning networks can obtain output from expert systems and learn corrections for the expert systems based on the provided output.

In general, the quality and accuracy of a human performance reviewer can be restricted by an amount or type of data to be processed as well as the corresponding connections between such data and key performance indicators for a given employee. An expert system can aid an organization by providing a way to parse and provide feedback for improvements. Using the technology described herein, such an expert system can be improved using machine learning models e.g., based on subsequent data obtained from one or more user devices. Improved expert systems allow improvement feedback from a given improved expert system to change over time. As suggestions are tried and are either fully successful, partially successful, or not successful a corresponding optimizing machine learning model can adjust the expert system without time consuming manual tuning of a given starting expert system. Optimization can further include performance improvements for the underlying expert systems, such as trimming of unnecessary logical pathways, among others. Machine learning enhanced expert systems, as opposed to trained machine learning models, allow for explainable output based on changes provided by the machine learning model to a given improved expert system. Unlike a machine learning model, an expert system can have fixed, human readable and understandable decision branches as opposed to traditional statistically-based layers of a machine learning model. The fixed, human readable and understandable decision branches can be updated periodically based on a separate machine learning model to enhance the given expert system over time while maintaining human readability and understandability.

In some implementations, an expert system is used to determine one or more of the following: (i) a metric represented in obtained user data, the metric being indicative of the performance of an employee, e.g., the metric having a value below a threshold indicating that the employee is not meeting performance standards, e.g., sale data indicating an amount of money given by a client for a sale, (ii) a likely cause that explains the value of the metric, e.g., conversation data from one or more devices indicating a number of times a keyword is used by an employee, and (iii) a recommended intervention intended to address the cause, e.g., instruction to review an article, book, textbook, blog post, video, among others. One or more machine learning models can be trained to provide updates to the expert system. For example, a first machine learning model can be trained to adjust which metrics to parse to analyze/represent the performance of an employee. In some implementations, a second machine learning model can be trained to adjust a list of possible causes from which the expert system chooses a cause correlated with a determined metric. In some implementations, a third machine learning model can be trained to determine/adjust a list of one or more interventions selectable by the expert system to correct a determined cause, or to determine/adjust a weighting associated with multiple interventions selected by the expert system.

In some implementations, a machine learning model is trained using performance data obtained after an intervention recommended by the expert system has been implemented. In some implementations, the performance data can be obtained from one or more user devices associated with a given user. For example, a system for obtaining user data can provide a unique identifier for one or more devices of a given user. Data obtained from the one or more devices can include the unique identifier. The system can associate the data including the unique identifier to the given user based on determining the unique identifier matches a provided identifier for the given user.

In some implementations, the expert system can be initiated with expert-compiled databases indicating metrics of interest, causes, and possible interventions. Using the initial expert system, an organization can track and offer interventions to improve employee performance. The identified metric, cause, and intervention used can be added to a database of user data, e.g., for each employee. Subsequent user data, such as user data indicating performance of an employee, obtained after an intervention has been implemented, can be added to the database. The subsequent user data is indicative of the effects of the intervention, and combined with a previously identified metric, cause, and intervention, can be used to train one or more ML models, e.g., a first model to adjust identified metrics, a second model to adjust causes, and/or a third model to adjust recommended interventions.

Advantageous implementations can include one or more of the following features. For example, enhanced expert systems can benefit from machine learning based improvements over time. Enhanced expert systems can include human readable and human understandable decision trees indicating results provided to users based on input. Unlike exclusively trained machine learning models, enhanced expert systems can be reviewed by human operators to ensure the decision trees conform with determined standards, e.g., of ethics, policy, among others. Reasoning can also be provided with a recommendation provided by an enhanced expert system. For example, if a suggestion was generated based on a chance from a machine learning model, an enhanced expert system can indicate that the result was not originally programmed by experts but was added later after one or more iterations of optimization from one or more optimizing machine learning models. Enhanced expert systems can achieve greater accuracy in predictions or processing results compared to starting expert systems or un-optimized expert systems. Enhanced expert systems, unlike traditional expert systems, can change over time to reduce error based on subsequent user data.

One innovative aspect of the subject matter described in this specification is embodied in a method that includes providing by an expert system over a user-interface, based on a first set of user data obtained from one or more computing devices, a recommended intervention pertaining to job-performance of a first user; obtaining, subsequent to providing the recommended intervention, a second set of user data from the one or more computing devices; providing the first set of user data to a machine learning model; obtaining, in response to providing the data, an output from the machine learning model indicating an adjustment to the expert system; and generating, using the adjusted expert system and the second set of user data from the one or more computing devices, a second recommended intervention different than the provided recommended intervention pertaining to the performance of the first user, wherein the second recommended intervention is presented on the interface of the one or more computing devices.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, the recommended intervention comprises data indicating: an identified metric of the data obtained from the one or more computing devices.

In some implementations, the recommended intervention comprises data indicating: a cause determined to be affected by the recommended intervention.

In some implementations, actions include storing in memory (i) the recommended intervention and (ii) the second set of user data from the one or more computing devices with the first identifier that identifies the first user.

In some implementations, the second set of user data includes recognized words spoken by the first user.

In some implementations, the second set of user data includes recognized words included by the first user in an electronic message or electronic mail.

In some implementations, actions include combining the first user data with the second set of user data; and providing the combined user data to the machine learning model with the data indicating the recommended intervention.

In some implementations, actions include determining that the first user data and the second set of user data both include the first identifier of the first user; and in response to determining that the first user data and the second set of user data both include the first identifier of the first user, combining the first user data with the second set of user data.

In some implementations, the output from the machine learning model indicating the adjustment to the expert system comprises data indicating a new cause affecting job-performance of the first user not included in a previous set of causes accessible by the expert system.

In some implementations, the output from the machine learning model indicating the adjustment to the expert system comprises data indicating a new intervention that affects job-performance of the first user not included in a previous set of interventions accessible by the expert system.

In some implementations, the output from the machine learning model indicating the adjustment to the expert system comprises data indicating a new metric that represents an aspect of job-performance of the first user not included in a previous set of metric accessible by the expert system.

In some implementations, actions include generating the adjusted expert system by adjusting the expert system using the output from the machine learning model indicating the adjustment to the expert system.

In some implementations, the first user data includes data obtained from one or more of a calendar application, email application, voice calls, voice call logs, or user resource systems.

In some implementations, the output from the machine learning model includes a set of weights for the expert system to prioritize one or more rules where multiple rules are applicable to select an intervention in response to a given set of conditions.

In some implementations, the machine learning model is trained to generate adjustments for the expert system.

In some implementations, obtaining, subsequent to providing the recommended intervention, the second set of user data from the one or more computing devices comprises: obtaining, subsequent to providing the recommended intervention, the second set of user data from the one or more computing devices over a period of time different from a period of time within which the first set of user data is obtained.

In some implementations, the expert system operates according to one or more if-then rules.

In some implementations, the output from the machine learning model indicates an adjustment to an if-then rule of the one or more if-then rules.

Another innovative aspect of the subject matter described in this specification is embodied in a method that includes providing by an expert system over a user-interface, based on first set of user data obtained from one or more computing devices, a recommended intervention pertaining to job-performance of a first user; obtaining, subsequent to providing the recommended intervention, second set of user data from the one or more computing devices; providing data indicating a first identifier of the first user, the recommended intervention, and the second set of user data from the one or more computing devices, to a machine learning model; obtaining, in response to providing the data, an output from the machine learning model indicating an adjustment to the expert system; and generating, using the adjusted expert system and the second set of user data from the one or more computing devices, a second recommended intervention pertaining to the performance of the first user, wherein the second recommended intervention is presented on the interface of the one or more computing devices.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for machine learning optimization of expert systems.

FIG. 2 is a flow diagram illustrating an example of a process for machine learning optimization of expert systems.

FIG. 3 is a diagram illustrating an example of a computing system used for machine learning optimization of expert systems.

Like reference numbers and designations in the various drawings indicate like elements.

### DETAILED DESCRIPTION

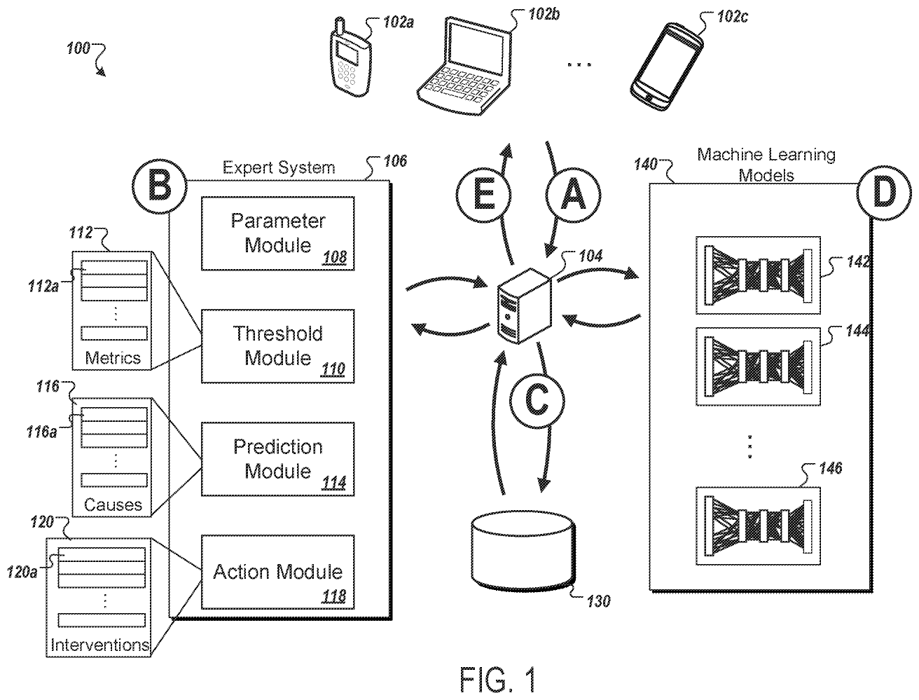

FIG. 1 is a diagram showing an example of a system 100 for machine learning optimization of expert systems. The system 100 includes a processor 104, an expert system 106, and one or more machine learning models 140. The processor 104 obtains data from devices 102a-c and provides the data to the expert system 106. The processor 104 can store the data in a storage device 130. In general, the expert system 106 can generate actions based on the data obtained from the devices 102a-c and the machine learning models 140 can optimize the expert system 106 to improve the actions generated by the expert system 106.

In stage A, the processor 104 obtains data from the devices 102a-c. The data can include data from one or more applications running on the devices 102a-c. Applications can include work place applications, email, texting, internet usage, voice recordings, phone call history, among others.

In some implementations, the processor 104 sends a request to the devices 102a-c to obtain data. For example, a request sent by the processor 104 can be configured to obtain data from one or more storage devices communicably connected to the devices 102a-c. In some implementations, the processor 104 receives data from the devices 102a-c. For example, the devices 102a-c can send data in communication signals over one or more networks to the processor 104.

In stage B, the processor 104 provides data from one or more of the devices 102a-c to elements of the expert system 106. Elements of the expert system 106 include a parameter module 108, a threshold module 110, a prediction module 114, and an action module 118. In some implementations, the expert system 106 is operated by one or more computer processors, such as one or more processors communicably connected to the processor 104.

The parameter module 108 of the expert system 106 obtains data from one or more of the devices 102a-c. The parameter module 108 identifies one or more parameters of the data. Parameters can include elements of data that influence actions by users of the devices 102a-c. For example, parameters can include trackable metrics for sales associates such as deal size or frequency. In general, parameters can include any data that is captured by one or more of the devices 102a-c and obtained by the processor 104. Parameters can include possible actions that can be performed by the expert system 106 as a result of processing by processor 104.

The threshold module 110 of the expert system 106 applies one or more thresholds to one or more parameter metrics identified by the parameter module 108 in data from one or more of the devices 102a-c. In some implementations, starting thresholds are manually populated. The thresholds applied by the threshold module 110 can be updated by one or more of the machine learning models 140. The threshold module 110 can identifying a metric 112a of metrics 112 that satisfies one or more thresholds. The metric 112a can include sale data for a specific user of one or more of the devices 102a-c, the sale data including, for example, an average sale price in final sales by the user, a largest sale in a past time period, among other metrics corresponding to a sale price parameter.

The prediction module 114 determines one or more causes 116 using the metrics 112 identified by the threshold module 110. The causes 116 can include actions that affect the metrics 112 identified. In some implementations, the causes 116 include a number of keyword mentions by a user of one or more of the devices 102a-c in communication with a potential customer. For example, the devices 102a-c or the processor 104 can obtain communication data and generate a textual representation of the communication, e.g., using speech to text processing, that can be parsed by the expert system 106 to detect the keywords. In some implementations, the expert system 106 parses the communications to determine frequencies of certain keywords attributed to positive or negative outcomes, such as high sales or low sales, respectively, or high client satisfaction or low client satisfaction, respectively, among others.

In some implementations, the causes 116 include a status of one or more informational modules completed or reviewed by a user of one or more of the devices 102a-c. For example, data obtained by the processor 104 can include a status of one or more informational modules consumed by a user of one or more of the devices 102a-c. The prediction module 114 can determine if a user has not completed one or more modules for learning a particular skill or gaining certain knowledge. Based on such a determination, the prediction module 114 can add a corresponding cause, e.g., cause 116a, to the causes 116. In some implementations, the prediction module 114 selects one or more causes from a predefined databases of causes, e.g., for a given one or more metrics identified by the threshold module 110.

The action module 118 selects one or more interventions 120 using the identified metrics 112 and causes 116. The interventions 120 can represent actions to be taken by a user of one or more of the devices 102a-c to address one or more of the causes 116 that affect one or more of the metrics 112 identified by the threshold module 110. In some implementations, one or more of the interventions 120 include instructions to view particular information. For example, intervention 120a can include an instruction to review an article, book, textbook, blog post, video, among others to help alleviate an action that caused one or more of the identified metrics 112.

In stage C, the processor 104 stores data in the storage device 130. The data stored in the storage device 130 can include data from one or more of modules of the expert system 106, including the metrics 112, the causes 116, and the interventions 120. The data stored in the storage device 130 can include data obtained from one or more of the devices 102a-c.

In some implementations, data stored in the storage device 130 is organized according to a predetermined schema. For example, the data stored in the storage device 130 can be stored such that data corresponding to a particular user or group of users is correlated, e.g., by a parameter of one or more elements of data being the same or sharing a prefix or suffix character. In this way, the data stored in the storage device 130 can be parsed to determine user actions and data generated by the expert system 106 for the given user over time. In some implementations, the data stored in the storage device 130 is stored in time increments. For example, the data stored in the storage device 130 can be stored in segments of data storage corresponding to a day, a week, a month, or other time range.

In some implementations, data corresponding to the same user or group of users over a period of time is stored in adjacent bits on a computer readable storage medium. For example, a computer readable storage medium can store one or more bits of information corresponding to a user or group of users, e.g., group of users at a particular company or across companies performing a same or similar role. The processor 104 can write that data to a storage device, such as the storage device 130. To improve access times when determining adjustments to the expert system using one or more of the machine learning models 140, data for a user or group of users can be stored in adjacent memory cells of the storage device 130. The storage location can be indicated by a unique identifier for the given user or group of users. In some implementations, other parameters can be used to determine a unique identifier corresponding to an area of the storage device 130 that stores data for a particular user or group of users.

In stage D, the one or more machine learning models 140 generate adjustments for the expert system 106. For example, a different action can be selected for a specific decision rule within the expert system 106, or the parameters for cut-offs within a decision rule can be changed within the expert system 106 with a unique weighting mechanism, e.g., from 0 to 1, that monitors and compares the expert system recommendations to ML model recommendations in real-time. Weighting can be based on one or more probabilistic model algorithmic reward measures that monitor real world performance of previous recommendations and selects those that maximize a probability of improving future performance of a seller, e.g., in one or more of the following metrics: more sales, bigger sales, more frequent sales, or more loyal customers. A set of recommendation strategies with a highest weighting that optimizes a potential for future performance can be provided to a system user. The processor 104 provides data, e.g., data stored in the storage device 130, to the one or more machine learning models 140. The processor 104 obtains output from the one or more machine learning models 140 indicating adjustments or instructions to directly adjust one or more modules of the expert system 106.

In some implementations, the machine learning models 140 include one or more of a first model 142, a second model, and a third model 146. Three models are shown and described for illustrative purposes. In other implementations, more or fewer models can be used. In some implementations, the first model 142 can perform adjustments for one or more of the parameter module 108 or the threshold module 110. The second model 144 can perform adjustments for the prediction module 114. The third model 146 can perform adjustments for the action module 118.

In some implementations, one or more of the machine learning models 140 are trained by the processor 104. For example, the first model 142 can be trained to improve the list of metrics or corresponding thresholds for identified parameters, such as improving the list of metrics to include metrics that are indicative of causes that have been successfully resolved or metrics that are exhibited by a portion of a population (e.g., high achieving persons, among others). The processor 104 can provide data to the first model 142 indicating data for a user of one or more of the devices 102a-c over a captured period of time, e.g., a week, month, year, among others. The processor 104 can provide data to the first model 142 indicating metrics, causes, or interventions identified by the expert system 106. In particular, the processor 104 can provide data indicating identified parameters, corresponding metrics, and thresholds used for those metrics. The processor 104 can provide data to the first model 142 indicating data for the given user of one or more of the devices 102a-c over a captured period of time, e.g., a week, month, year, among others, after the expert system 106 has generated prediction or output for the given user. In this way, the model 142 can obtain from the processor 104 data used by the expert system 106 to generate data, such as the identified metrics and thresholds, and data obtained from a given user or group of users after a given intervention was enacted corresponding to the identified metrics and corresponding thresholds.

In some implementations, the first model 142 generates one or more simulations of the expert system 106. For example, the first model 142 can determine potential interventions that would have been enacted, e.g., sent to a user device and performed by a corresponding user, if another metric was identified. In some implementations, the first model 142 minimizes a predicted metric corresponding to a metric identified by the expert system 106 for a given user. For example, if the expert system 106 identified sale size as a metric of concern for a user, the first model 142 can process data from the user after a corresponding cause and intervention have been determined to affect that metric. The first model 142 can determine one or more adjustments to identified metrics, including a set of metrics that are identified from one or more parameters, or one or more thresholds used for corresponding metrics.

In some implementations, the machine learning models 140 are trained using one or more selected interventions. For example, the processor 104 can compare predictions of interventions with effects of selected interventions to determine if interventions were accurately selected. If one or more interventions were not selected and a selected intervention improved one or more metrics, the processor 104 can generate rewards for one or more of the models 140 to increase a likelihood of generating similar intervention predictions for future user data. In some implementations, the models 140 generate an intervention that is different from the expert system 106. The processor 104 can penalize or not penalize one or more of the models 140. In general, if a prediction generated by one or more of the models 140 is not used by a user, the processor 104 can limit or eliminate corresponding adjustments to the models 140. In contrast, actions taken based on the models 140 can be tracked to determine if one or more metrics improved or did not improve. One or more of the models 140 can be adjusted, e.g., by the processor 104 using one or more training algorithms, to increase a likelihood of generating predictions that improve one or more tracked metrics.

In some implementations, the second model 144 is trained by the processor 104. In some implementations, the second model 144 is trained to improve a list of causes generated by the expert system 106. Causes, similar to metrics, can be improved by removing one or more causes that have been used for providing recommendations that have not been successful or by adding one or more causes that have been used for providing recommendations that have been successful. For example, if a cause is added, then a new condition is added to the expert system 106 as a rule that can be used to produce recommendations.

The second model 144 can use association rule mining to improve the causes 116 identified by the prediction module 114. In some implementations, association rule mining includes one or more algorithms configured to search for patterns. For example, patterns can include a set of values of variables, such as if clauses in if-then clauses used to determine actions in the expert system 106, that predict another variable's value, e.g., the then clauses in the if-then clauses of the expert system 106. Association rule mining can be used by the second model 144 to generate hypotheses to study further and for finding unexpected connections within the data, e.g., data obtained from one or more of the devices 102a-c.

In some implementations, training of the second model 144 is similar to training of the third model 146 described below. For example, the processor 104 can adjust the second model 144 based on the selections made by the prediction module 114. If the prediction module 114 selects a cause that remedies an issue, or improves one or more tracked metrics, and that cause was not predicted by the second model 144, or did not have a highest confidence value associated with it, the processor 104 can adjust one or more weights or parameters of the second model 144 to increase the likelihood of predicting the given cause for similar input in the future.

In some implementations, association rule mining is used within the system 100 or the second model 144 to perform one or more adjustments on the prediction model 114 or the expert system 106. For example, association rule mining can be used to improve a list from the expert system 106 of possible causes, e.g., causes 116, corresponding to a particular metric or set of metrics that satisfy one or more thresholds, e.g., that are below one or more expectations for performance. Association rule mining can be used to analyze interactions between sellers to find rules that predict seller success, e.g., keyword usage in communication to clients that is associated with a subsequent sale that meets one or more conditions or thresholds. Association rules from association rule mining can be used to match suitable prescriptive materials based on each seller's specific targeted needs. Such targeted needs can be determine based on data obtained from one or more of the devices 102a-c.

Association rule mining can be used to make recommendations to third parties associated with users, such as managers or sales coaches, indicating how to improve an effectiveness of a prescribed course of action, e.g., an intervention determined by the expert system 106. Recommendations can include next best steps for a given user to take. Association rule mining can be used to provide information to coaches about sellers' behavior inside a given system, such as a system of applications that are used to perform one or more actions that are tracked on one or more of the devices 102a-c. Association rule mining can be used to analyze how sellers engage in different activities within a given system change over time. In particular, studying different sequences seen in high performing and low-performing users, e.g., sellers, with one or more algorithms, such as Differential Sequence Mining, a related algorithm.

In some implementations, the second model 144 determines one or more association rules to perform one or more adjustments on the prediction model 114 or the expert system 106. For example, the second model 144 can perform one or more operations corresponding to Sequential Pattern Mining. Sequential Pattern Mining can include determining association rules where contents of a then-clause, such as a then clause of an if-then logic step in the expert system 106, that occurs temporally after contents of an if-clause.

In some implementations, the second model 144 uses a type of Sequential Pattern Mining, such as Differential Sequence Mining, to analyze how users or groups of users interact with tools, such as applications running on one or more of the devices 102a-c. The second model 144 can obtain data corresponding to a user or group of users obtained from one or more of the devices 102a-c. The second model 144 can determine work patterns of successful and unsuccessful groups. The second model 144 can determine traits of users that successfully perform one or more tasks and traits of users that do not. Traits can include frequencies of keywords mentioned, time spent performing one or more actions, among others.

In some implementations, data indicating traits identified by the second model 114 as corresponding to successful users is added by the second model 144 into a database of causes from which the prediction model 114 generates the list of causes 116. The second model 144 can determine metrics where successful users excel and determine corresponding metrics as keys, e.g., in if-then clauses added by the second model 114 to the expert system 106, to select the given additional causes added to the database for the expert system 106. In some implementations, the additional causes added to the database are included in if-then clauses added into the logic system of the expert system 106. For example, the second model 144 can generate new if-then clauses for the expert system 106 to perform. A new if-then clause can include determining, for a user that lacks one or more traits of a successful user, a cause corresponding those same successful user traits as a cause for one or more identified metrics.

In some implementations, the second model 114 uses Correlation Mining to determine effect sizes. For example, the prediction module 114 of the expert system 106 can determine weights for one or more potential causes in order to determine one or more causes for the generated causes 116. The second model 114 can determine effect sizes and adjust one or more logical processes for the expert system 106 to change a calculation of weights for one or more causes based on the effect sizes. Effect size can include an indication of how many users likely are affected by a given cause that contributes to performance. The second model 114 can adjust one or more weights for causes stored in a database for the expert system 106 that are more common within a given group of users than other causes stored in the database such that the prediction module 114 ranks those causes higher and is more likely to select them for the causes 116.

In some implementations, the expert system 106 provides feedback to one or more users. For example, the expert system 106 can provide feedback to user or groups of users about potential causes that are correlated to their work strategies. In some implementations, the expert system 106 ranks one or more causes in the prediction module 114. For example, the prediction module 114 can access one or more causes based on identified metrics 112. The causes can be ranked according to weights associated with the one or more causes. The weights can be static or can be dynamic determined by the expert system 106. Dynamic weights can be generated by the expert system 106 based on a set of identified metrics, a specific user corresponding to data being processed, or a group or users within which a user whose data is being processed is a part of.

In some implementations, the rules, such as if-then clauses, which govern the operation of the expert system 106 change depending on data being processed. For example, for a first user or group of users, the expert system 106 can use a first set of rules. For a second user or group of users, the expert system 106 can use a second set of rules. Different sets of rules can have different data, e.g., metrics, causes, interventions, to choose from. Different sets of rules can assign different weights to different items of data, e.g., metrics, causes, interventions, among others.

In some implementations, the third model 146 uses reinforcement learning to adjust the action module 118. For example, the action module 118 of the expert system 106 choose between multiple potential interventions to mitigate or eliminate a given cause of an identified metric satisfying one or more thresholds, e.g., to correct performance. In some implementations, the third model 146 adjusts how the action module 118 selects an intervention or what intervention the action module 118 selects. The third model 146 can use reinforcement learning techniques. The third model 146, similar to one or more other models of the machine learning models 140, can obtain data from the processor 104. The data from the processor 104 can include data from the devices 102a-c and data from the expert system 106. The third model 146 can be trained to maximize an effect of prescribing an intervention on the corresponding metrics of interest, e.g., maximize improvement for a given user. The third model 146 can similarly be trained to achieve a minimum in a value representing negative performance.

In some implementations, the processor 104 trains the third model 146. For example, the processor 104 can provide data that is provided to the expert model 106 for it to determine one or more interventions, such as the interventions 120. The third model 146 can predict a set of interventions. The processor 104 can obtain subsequent data from one or more of the devices 102a-c. The processor 104 can determine a difference in the activity of a user based on subsequent data obtained. If the interventions predicted by the third model 146 were different from the interventions selected by the action module 118 and the subsequent data indicates that the interventions were not successful, e.g., did not remedy one or more identified metrics, the processor 104 can reward the third model 146 by biasing the weights to choose the different interventions. The processor 104 can include the different interventions in a database accessible by the action module 118 or adjust logical rules of the expert system 106 such that the different interventions are more likely to be selected by the action module 118 in a next processing cycle.

In some implementations, the processor 104 adjusts weights of the third model 146 to reduce a bias for a given set of generated predictions. For example, if the interventions predicted by the third model 146 are different from the interventions selected by the action module 118 and, based on subsequent data obtained from one or more of the devices 102a-c, the interventions selected by the action module 118 improved one or more identified metrics, the third model 146 can adjust one or more weights of the third model 146 to de-bias the predictions of the corresponding interventions for the given set of input, e.g., data obtained from one or more of the devices 102a-c.

In some implementations, the processor 104 adjusts weights of the third model 146 to change output of the third model 146. For example, if the interventions selected by the action module 118, e.g., the interventions 120, match the interventions predicted by the third model 146 using the same input data, and the selected interventions did not remedy one or more identified metrics over a given period of time, e.g., different interventions may have different time scales for expected effect, the processor 104 can adjust one or more weights of the third model 146 to change the output such that, for the same input, the third model 146 generates different output. In some implementations, the processor 104 can use one or more random or pseudo random values to adjust weights in order to generate different output for the third model 146.

After training of models, the processor 104 can provide data to the one or more models 140 to generate adjustments for the expert system 106. In some implementations, one or more of the models 140 generate output that indicate weights or if-then rule adjustments or additions. For example, the processor 104 can provide data of the devices 102a-c to the third model 146. The third model 146 can calculate a predicted set of interventions. The processor 104 can compare the predicted set of interventions to an actual selection of interventions by the expert system 106. If the interventions do not match, the processor 104 can adjust the expert system 106, e.g., the action module 118, based on the output of the third model 146 to align with the output of the third model 146. The adjustments can include adjusting weights of the expert system 106 corresponding to actions of the action module 118 or if-then rule adjustments including additions or removal of if-then rules.

In some implementations, the expert system 106 is adjusted to approximate the trained models 140. For example, machine learning models typically suffer from a lack of explainability making their use in situations where decisions require explanation difficult. By adjusting the expert system 106 to approximate one or more decisions or predictions of the models 140, the processor 104 and the system 100 can generate a more explainable form of the trained models 140 that can be explained, e.g., in terms of the if-then rule implementation of the expert system 106. By formulating the intricacies of the models 140 as a collection of if-then rules, the system 100 can increase explainability of the models 140 output and more easily adjust one or more if-then associations based on expert knowledge or other goals or interests.

In general, the system 100 can use three key inflection points to algorithmically adjust operations of the expert system 106. The expert system 106 can determine the biggest problems for a given user or group of users being processed, e.g., in the operations of the parameter model 108 and the threshold module 110. The expert system 106 can determine what indicators or causes are most relevant to remedying those problems, e.g., in the operations of the prediction module 114. The expert system 106 can determine a recommendation to solve the issue that's causing the problem, e.g., in the operations of the action module 118.

In some implementations, the expert system 106 determines interventions based on a context of a user or group of users being processed. In some implementations, keeping the three steps of the expert system 106 separate allows for testing different algorithmic frameworks for each inflection point. The machine learning techniques used to adjust and optimize the expert system over time can be adjusted as machine learning methods advance. Other learning techniques can be used alongside other techniques to perform adversarial optimization with multiple training techniques. For example, any of the models of the one or more models 140 can be paired with an adversary. The adversary can employ a different machine learning method, e.g., from a predetermine list or chosen at random from a list, and the processor 104 determines which predictions are most likely to remedy a given identified metric for a given user or group of users. If an adversarial model beats an existing model, the existing mode, e.g., the first model 142, can be replaced with the techniques, weights, layers, among other elements, of the adversarial model and the adversarial model can be replaced with another type of model to continue the optimization of the adjustments.

In general, the system 100 can be used to continuously improve the expert system 106 at, at least, 3 major inflection points, e.g., parameter and threshold module 108 and 110, the prediction module 114, and the action module 118. The one or more machine learning models 140 can identify and improve on elements of the expert system 106, such as lists of causes for poor performance, can determine effect sizes of causes for specific cases, can use reinforcement learning based on past interventions and comparisons of data before and after the intervention on actions of a user or group of users to adjust one or more elements of the expert system 106. The incremental adjustments can be stored and provided to one or more users when provided with output from the expert system 106. The user can see a portion of data or a series of iterations of adjustments that led to a given adjustment corresponding to output they received. In this way, the user can better understand the operations of the expert system 106.

The expert system 106 can be initially seeded using past experience of humans, e.g., sales trainers or initial human-driven data analysis. The expert system 106 can be optimized using the one or more machine learning models 140. In some implementations, the one or more machine learning models 140 add new rules for the expert system 106 to execute. The one or more models 140 can de-emphasize some expert rules that are less actionable or accurate than similar rules that a given model of the one or more models 140 identifies.

In one case, the expert system 106 can determine that, based on a given identified metric, something is wrong with a performance of a user. The expert system 106 can include one or more if-then rules. The if-then rules can be a set of conditions and diagnoses. The expert system 106 can identify a metric using the parameter module 108 and the threshold module 110. The prediction module 114 can identify the most likely cause or list of causes, e.g., causes 116, and interventions 120 to help mitigate or eliminate the problems indicated by the identified metrics. In each case, the expert system 106 can operate using if-then rules which can be adjusted, added to, or removed by the one or more machine learning models 140. In some implementations, the expert system 106 starts with initial priorities selected by experts. The priorities, represented by one or more weights or rules of the expert system 106, can be adjusted by the one or more machine learning models 140 over time based on selections determined by the expert system 106 and subsequent data obtained from one or more of the devices 102a-c.

In stage E, the processor 104 provides output to one or more of the devices 102a-c. The output can be data generated by the expert system 106 or an optimized version of the expert system 106 optimized by one or more adjustments made by the one or more models 140. The output provided by the processor 104 can be generated by the processor 104. The output can be configured by the processor 104 to, when received by one or more of the devices 102a-c, render graphically on a display of one or more of the devices 102a-c. The output can indicate one or more interventions to be performed by a given device or a user of a given device.

Although discussed in stages for ease of description, the operations described in regard to FIG. 1 can be performed in different orders than that described. For example, the processor 104 can store data from the devices 102a-c before providing the data to the expert system 106. In some implementations, the machine learning models 140 provide one or more adjustments to the expert system 106 before the expert system 106 has generated an action. For example, for each portion of the expert system 106, an intermediary result can be generated by the expert system 106. One or more of the machine learning models 140 can use the generated intermediary result to optimize the corresponding portion of the expert system 106. Such optimization can be independent from a final action determination by the expert system 106.

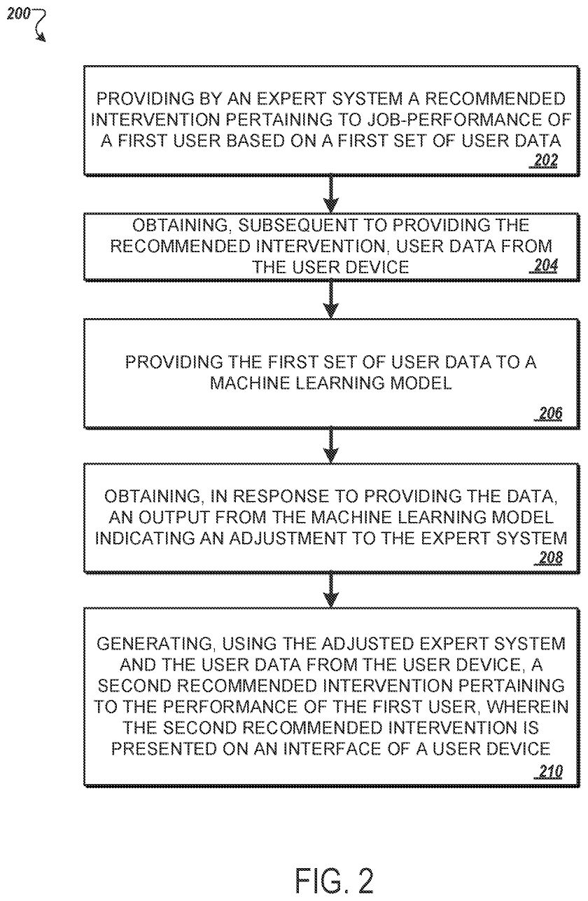

FIG. 2 is a flow diagram illustrating an example of a process 200 for machine learning optimization of expert systems. The process 200 may be performed by one or more electronic systems, for example, the system 100 of FIG. 1.

The process 200 includes providing by an expert system a recommended intervention pertaining to job-performance of a first user based on a first set of user data (202). For example, the processor 104 can provide a recommended intervention, e.g., the intervention 120a, to one or more of the devices 102a-c. The intervention 120a can include instructions for actions to be performed on a given device or by a user of the device.

The process 200 includes obtaining, subsequent to providing the recommended intervention, user data from the user device (204). For example, the processor 104 can obtain data from one or more of the devices 102a-c after providing data indicating an intervention generated by an initial version of the expert system 106. The user data can be obtained over a different time period compared to user data obtained to generate the recommended intervention in step 202.

In some implementations, the process 200 includes providing the first set of user data to a machine learning model (206). For example, the processor 104 can provide data, e.g., data stored in the storage device 130, to the one or more machine learning models 140, as described in reference to FIG. 1. The first set of user data can be obtained prior to the user data obtained from the user device in step 204. By obtaining both the data used to generate the recommended intervention and subsequent data after the intervention, the processor 104 can train the models 140 and adjust the expert system 106 to generate intervention predictions that have a higher likelihood of improving one or more metrics of interest, e.g., metrics indicated by data obtained from one or more user devices, emails, calendars, or other data sources.

In some implementations, the process 200 includes providing data indicating a first identifier of the first user, the recommended intervention, and the user data from the user device, to a machine learning model. For example, the processor 104 can obtain identifying data from one or more of the devices 102a-c indicating a specific one or more users. The processor 104 can determine an error value between a prediction of a model of one or more of the models 140 and values generated by the expert system 106 relative to an outcome indicated by data from the devices 102a-c.

In some implementations, the processor 104 provides the data to a given model and the model, such as the second model 144, determines an error term based on the recommended intervention, or other data generated by the expert system 106. The processor 104 or the model itself can adjust one or more weights or parameters of the model to optimize weights or rules provided by the model to adjust the expert system 106.

The process 200 includes obtaining, in response to providing the data, an output from the machine learning model indicating an adjustment to the expert system (208). For example, the processor 104 can obtain weights generated by one or more of the machine learning models 140. The weights can indicate specific if-then rules operated by the expert system 106 and increase some rules or results over others.

In some implementations, the processor 104 can obtain new if-then rules generated by one or more of the models 140. For example, the second model 144 can generate a new if-then rule that includes a new cause not included in a database of clauses used by the prediction module 114 to generate a set of causes. In another example, the first model 142 can adjust an if-then rule to change a threshold applied by the threshold module 110 or a parameter selected from data provided by the processor 104 by the parameter module 108.

The process 200 includes generating, using the adjusted expert system and the user data from the user device, a second recommended intervention pertaining to the performance of the first user, wherein the second recommended intervention is presented on an interface of a user device (210). For example, after the one or more models 140 provide adjustments to the processor 104 and optimize the expert system 106, the expert system 106 can obtain subsequent data from one or more of the devices 102a-c. The expert system 106 can process the data according to one or more adjusted weights or if-then rules. The expert system 106 can provide updated output, including a recommendation, to the processor 104 and the processor 104 to one or more of the devices 102a-c corresponding to a user or group of users whose data was processed by the expert system 106 to generate the updated output. The processor 104 can provide the output to multiple devices associated with a given user.

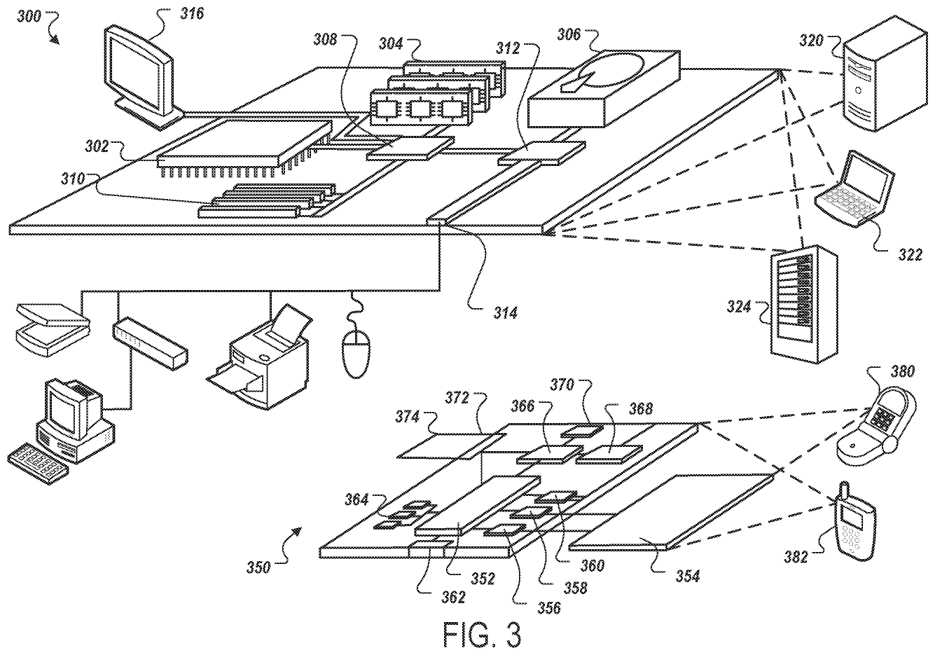

FIG. 3 is a diagram illustrating an example of a computing system used for machine learning optimization of expert systems. The computing system includes computing device 300 and a mobile computing device 350 that can be used to implement the techniques described herein. For example, one or more components of the system 100 could be an example of the computing device 300 or the mobile computing device 350, such as a computer system implementing the processor 104, devices that access information from the processor 104, or a server that accesses or stores information regarding the operations performed by the processor 104.

The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 302 is a single threaded processor. In some implementations, the processor 302 is a multi-threaded processor. In some implementations, the processor 302 is a quantum computer.

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine readable mediums (for example, the memory 304, the storage device 306, or memory on the processor 302). The high-speed interface 308 manages bandwidth-intensive operations for the computing device 300, while the low-speed interface 312 manages lower bandwidth-intensive operations. Such allocation of functions is an example only. In some implementations, the high speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device, such as a mobile computing device 350. Each of such devices may include one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provide as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 352), perform one or more methods, such as those described above. The instructions can also be stored by one or more storage devices, such as one or more computer- or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry in some cases. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 368 using a radio frequency. In addition, short-range communication may occur, such as using a Bluetooth, Wi-Fi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, among others) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method, comprising:
providing by an expert system over a user-interface, based on a first set of user data obtained from one or more computing devices, a recommended intervention pertaining to job-performance of a first user;
obtaining, subsequent to providing the recommended intervention, a second set of user data from the one or more computing devices;
providing the first set of user data to a machine learning model;
obtaining, in response to providing the data, an output from the machine learning model indicating an adjustment to the expert system; and
generating, using the adjusted expert system and the second set of user data from the one or more computing devices, a second recommended intervention different than the provided recommended intervention pertaining to the performance of the first user, wherein the second recommended intervention is presented on the interface of the one or more computing devices.

2. The method of claim 1, wherein the recommended intervention comprises data indicating:
an identified metric of the data obtained from the one or more computing devices.

3. The method of claim 1, wherein the recommended intervention comprises data indicating:
a cause determined to be affected by the recommended intervention.

4. The method of claim 1, comprising:
storing in memory (i) the recommended intervention and (ii) the second set of user data from the one or more computing devices with the first identifier that identifies the first user.

5. The method of claim 1, wherein the second set of user data includes recognized words spoken by the first user.

6. The method of claim 1, wherein the second set of user data includes recognized words included by the first user in an electronic message or electronic mail.

7. The method of claim 1, comprising:
combining the first user data with the second set of user data; and
providing the combined user data to the machine learning model with the data indicating the recommended intervention.

8. The method of claim 7, comprising:
determining that the first user data and the second set of user data both include the first identifier of the first user; and
in response to determining that the first user data and the second set of user data both include the first identifier of the first user, combining the first user data with the second set of user data.

9. The method of claim 1, wherein the output from the machine learning model indicating the adjustment to the expert system comprises data indicating a new cause affecting job-performance of the first user not included in a previous set of causes accessible by the expert system.

10. The method of claim 1, wherein the output from the machine learning model indicating the adjustment to the expert system comprises data indicating a new intervention that affects job-performance of the first user not included in a previous set of interventions accessible by the expert system.

11. The method of claim 1, wherein the output from the machine learning model indicating the adjustment to the expert system comprises data indicating a new metric that represents an aspect of job-performance of the first user not included in a previous set of metric accessible by the expert system.

12. The method of claim 1, comprising:
generating the adjusted expert system by adjusting the expert system using the output from the machine learning model indicating the adjustment to the expert system.

13. The method of claim 1, wherein the first user data includes data obtained from one or more of a calendar application, email application, voice calls, voice call logs, or user resource systems.

14. The method of claim 1, wherein the output from the machine learning model includes a set of weights for the expert system to prioritize one or more rules where multiple rules are applicable to select an intervention in response to a given set of conditions.

15. The method of claim 1, wherein the machine learning model is trained to generate adjustments for the expert system.

16. The method of claim 1, wherein obtaining, subsequent to providing the recommended intervention, the second set of user data from the one or more computing devices comprises:
obtaining, subsequent to providing the recommended intervention, the second set of user data from the one or more computing devices over a period of time different from a period of time within which the first set of user data is obtained.

17. The method of claim 1, wherein the expert system operates according to one or more if-then rules.

18. The method of claim 17, wherein the output from the machine learning model indicates an adjustment to an if-then rule of the one or more if-then rules.

19. A non-transitory computer-readable medium storing one or more instructions executable by a computer system to perform operations comprising:
providing by an expert system over a user-interface, based on a first set of user data obtained from one or more computing devices, a recommended intervention pertaining to job-performance of a first user;
obtaining, subsequent to providing the recommended intervention, a second set of user data from the one or more computing devices;
providing the first set of user data to a machine learning model;
obtaining, in response to providing the data, an output from the machine learning model indicating an adjustment to the expert system; and
generating, using the adjusted expert system and the second set of user data from the one or more computing devices, a second recommended intervention different than the provided recommended intervention pertaining to the performance of the first user, wherein the second recommended intervention is presented on the interface of the one or more computing devices.

20. A system, comprising:
one or more processors; and
machine-readable media interoperably coupled with the one or more processors and storing one or more instructions that, when executed by the one or more processors, perform operations comprising:
providing by an expert system over a user-interface, based on a first set of user data obtained from one or more computing devices, a recommended intervention pertaining to job-performance of a first user;
obtaining, subsequent to providing the recommended intervention, a second set of user data from the one or more computing devices;
providing the first set of user data to a machine learning model;
obtaining, in response to providing the data, an output from the machine learning model indicating an adjustment to the expert system; and
generating, using the adjusted expert system and the second set of user data from the one or more computing devices, a second recommended intervention different than the provided recommended intervention pertaining to the performance of the first user, wherein the second recommended intervention is presented on the interface of the one or more computing devices.
